(19) United States
(12) Patent Application Publication
(10) Pub. No.: US 2006/0141148 A1
(43) Pub. Date: Jun. 29, 2006

(54) Method for modifying microparticles and device for modifying microparticles

(75) Inventors: Andreas Voigt, Berlin (DE); Lars Dahne, Berlin (DE)

Correspondence Address: B. Todd Patterson;Ser Patterson & Sheridan, 3040 Post Oak Blvd.,, Suite 1500, Houston,, TX, 77056-6582, US

(73) Assignee: Capsulution NanoScience AG, Berlin (DE)

(21) Appl. No.: 10/535,714

(22) PCT Filed: Nov. 18, 2003
(86) PCT No.: PCT/EP03/12904

§ 371 Date: Dec. 12, 2005

(30) Foreign Application Priority Data
Nov. 22, 2002 (DE) 102 54 636.3

(51) Int. Cl. B05D 7/00

(52) U.S. Cl. 427/212; 118/13

(57) ABSTRACT

The invention relates to a gradual coating method (LBL-technology®) with poloyelectrolytes of microparticles and nanoparticles in aqueous gels and gelatinous media, whereby regularly occurring flocculation and coagulation problems,which arise as a result of high collision frequency (Brownian movement and/or hydrodynamic collision) amongst the particles to be coated and as a result of heterocoagulation with the coating material, can be avoided. The coating compositions are conveyed to the particles which are to be coated by diffusion or by means of external forces of an electric, magnetic, dielectrophoretic and hydrodynamic variety. According to the invention, the coated cores can be disintegrated or dispersed after coating while maintaining the integrity of the multi-layered shell. The coating products and/or the empty coating shells can be obtained once the gel has been broken and can be further processed.

The invention lies in the field of the production of coated microparticles, in particular hollow particles, and relates to a method for modifying microparticles, to a device for modifying microparticles, to a carrier material and to a column.

Hollow particles can be produced by coating template particles, with the template particles being provided as microparticles and with the microparticles subsequently being dissolved out. A method of this nature is described, for example, in WO 99/47252.

However, the coating and modification of microparticles in aqueous media in this way can frequently lead to phenomena of more or less irreversible coagulation and consequently to a diminished yield of dispersed micro-particles. These problems are particularly troublesome in the microparticle size window of from a few tens of nanometers up to a few micrometers.

As a rule, larger microparticles can be processed more readily because they only exhibit weak Brownian movement and are regularly easier to work up industrially using typical process modules such as filtration, centrifugation, etc. The low Brownian movement results in the frequency of the collisions between the microparticles being comparatively low, which means that coagulation or aggregate formation is only observed after relatively long periods of time. The tendency to coagulate or form aggregates can be further reduced by coating with appropriate coating components, such that a coating which is sufficiently rapid leads to stable dispersion. On the other hand, when the microparticles are comparatively large, any reversible aggregates which may possibly be formed can also be broken up by supplying energy to the system.

The situation is different in the case of micro-particles which undergo intense thermal motion. This phenomenon increases as the size and relative density of the microparticles decrease. Thus, it is difficult to coat microparticles having a diameter of less than 1 μm without loss or with little loss, i.e. without, or only with slight, irreversible aggregate formation, particularly if several layers have to be applied.

All the previously described industrial approaches take as their starting point systems in which the micro-particles are dispersed in a carrier liquid (WO 02/09864 A1) and in which the yield can be optimized by conducting the process using filtration (WO 99/47252), centrifugation (Sukhoroukov, G. B. et al., Polym. Adv. Technol. 1998, 9, 759; Sukhoroukov, G. B. et al., Colloids Surfaces A 1998 137, 253-266) or column methods (WO 01/64330).

However, the problem of troublesome coagulation or aggregate formation cannot be circumvented using these techniques and may even be exacerbated by conducting the process in the abovementioned manner.

The object of the present invention is therefore to specify a method which to a large extent avoids or alleviates the problems of the prior art and which, in particular, largely suppresses coagulation of the microparticles and the formation of aggregates by these microparticles.

This object is achieved by means of a method for modifying microparticles comprising the steps of:
providing a gelatinous carrier medium in which microparticles are embedded;
introducing at least one component into the gelatinous carrier medium and bringing the at least one component into contact with the microparticles by means of induced, directional transport, with the at least one component exhibiting a mobility in the gelatinous carrier medium which is higher than that of the microparticles;
modifying the microparticles with the at least one component; and
removing the modified microparticles from the gelatinous carrier medium.

The intention of embedding the microparticles to be modified in the gelatinous carrier medium is to substantially restrict the mobility of the micro-particles. This reduces the probability of even comparatively small microparticles colliding with each other, which means that coagulation or aggregate formation is reduced or even suppressed. The extent to which the mobility is restricted in connection with a given size of microparticles depends to a large extent on the viscosity of the gelatinous carrier medium, for example. The more viscous the carrier medium is, the greater is the degree to which the microparticles are immobilized and the lower is their mobility. This can extend to what is to a large extent complete immobilization as, for example, in the case of a solid gel, which as a rule exhibits very high viscosity.

The restriction in the mobility of the microparticles can also be made clear by the decrease in the diffusion coefficient. If the diffusion coefficient of free microparticles, i.e. of microparticles which are suspended in a low-viscosity medium, for example in an aqueous system, is assumed to be D₀, the diffusion coefficient of the microparticles in the gelatinous carrier medium, i.e. D_{gel}, is then substantially lower. Microscopically, this means that the microparticles display a Brownian movement which is substantially restricted.

The aim of embedding the microparticles in the gelatinous carrier medium is to reduce the mobility of the microparticles to such an extent that coagulation of the microparticles, or the formation of aggregates by these microparticles, is to a large extent avoided for the period of time which is required for the modification. It is therefore in principle not necessary for the gelatinous carrier medium to be a solid gel; instead, a gelatinous carrier medium of appropriately high viscosity is also frequently sufficient. When solid gels are used, the viscosity is particularly high, which means that virtually no movement of the microparticles is observed during the modification. The period of time which is required for the modification depends to a high degree on the nature of the modification. Thus, in the case of coating microparticles, for example, the total time made up of supplying the coating component, the duration of the requisite interaction and, where appropriate, the time required for removing excess coating components, has to be taken into consideration. If the microparticles are to be covered with several layers composed of different components, the total time taken for the coating then increases correspondingly. The embedding enables the process to be conducted in a very uniform manner

The provision of the gelatinous carrier medium preferably comprises the steps of:
providing the carrier medium in a low-viscosity form;
introducing microparticles into the carrier medium; and
increasing the viscosity of the carrier medium such that the mobility of the microparticles in the carrier medium is restricted.

Accordingly, microparticles are first of all introduced into, and dispersed as uniformly as possible in, the low-viscosity carrier medium. The viscosity of the carrier medium is then increased until the microparticles are adequately immobilized. The viscosity of the carrier medium is preferably increased by converting the carrier medium into a gelatinous state or into a solid gel. This can be effected, for example, by increasing the viscosity of the carrier medium by means of subjecting the carrier medium to a reversible sol-gel transition. In this way, it is possible to use, as the carrier medium, a gel which is liquefied by heating for the purpose of introducing the microparticles and then cooled once again, for solidification, after the microparticles have been introduced. On the other hand, a dispersing agent for effecting liquefaction can be added to the carrier material, in the form of a gel, fox the purpose of introducing the microparticles and at least some of the dispersing agent can be removed once again, after the microparticles have been introduced, for solidification purposes. It is also possible to control the viscosity by other means, for example by adding salts. In principle, the viscosity of the carrier medium can be increased by means of thermal, chemical, electrical, physicochemical, optical, mechanical, rheomechanical and biological processes and parameters.

The viscosity of the gelatinous carrier medium in which the microparticles are immobilized should preferably be at least 100 times higher than the viscosity of water. Gels are also frequently rated in accordance with their elasticity. Particularly preferably, the Bloom values characterizing the elasticity of the gelatinous carrier medium should correspond to those of the solidified solutions of gelatinizing agents in the concentration range of from 0.01% to 20% percent by weight.

On the other hand, the gelatinous carrier medium should still allow sufficient mobility of the components which modify the immobilized microparticles. It is advantageous if, for example, the diffusion of the components through the gelatinous carrier medium is only slightly restricted. Those gelatinous supporting media which, while substantially restricting the mobility of the microparticles, nevertheless, at the same time, constitute a sufficiently good solvent for the components which are to be conducted to the microparticles, are therefore of particular interest.

All structures in a size range less than 30 μm, preferably less than 5 μm and particularly preferably less than 1 μm, can be microparticles. The lower size of the microparticles corresponds to that of typical nanoparticles and consequently lies in the single-digit nanometer range, provided that the relative movement of the particles and of the components employed for coating is sufficiently large and allows the coating to be carried out. Biogenic or synthetic DNA and RNA, as well as biopolymers, can also, in particular, function as microparticles, as can complexes of the listed species with other components, e.g. lipids, fatty acids, histones and spermines.

The lower size of the microparticles is preferably determined by the microparticles allowing coating with coating components, in particular with poly-electrolytes. In this connection, particular preference is given to the microparticles being at least sufficiently large for a coating to be possible with at least two different coating components, e.g. oppositely charged polyelectrolytes, for the purpose of forming a shell which is at least double-layered. Examples are microparticles having a size of 30 nm or larger. These microparticles frequently already exhibit macroscopic boundary surface properties. The microparticles are preferably larger than 30 nm, particularly preferably larger than 50 nm. The microparticles can be solid, liquid, liquid-crystalline or gaseous particles as well as their intermediate forms. In this connection, the microparticles can be crystalline or amorphous. Preference is given to the microparticles being able to consist of aggregates of inorganic or organic colloids, or mixed aggregates obtained therefrom. In addition to this, disintegratable or soluble particles can also be used as microparticles The microparticles can be aggregates composed of similar or dissimilar components or constitute mixtures composed of at least two different types of microparticle. The microparticles can be monodisperse or heterodisperse. It is likewise possible for the microparticles to be templates for coatings or chemical reactions.

The microparticles can also contain an active compound. The active compound in this connection can be selected from catalysts, enzymes, pharmaceutical active compounds, nanoparticles, sensor molecules, crystals, polymers and gases.

In particular, the microparticles can be of biological or biotechnological origin, such as animal and human cells, plant cells, yeast cells and modified yeast cells; plant pollens and modified plant pollens; protoplasts; ghost envelopes, viruses, bacteria; liposomes and vesicles; cell organelles such as ribosomes, cell nuclei, plastids and mitochondria; membrane fragments containing active protein components such as channel proteins, transport proteins, proteins involved in electron transport and receptor proteins; biopolymers such as proteins, nucleic acids and carbohydrates; and precipitates of biogenic molecules. In particular, the microparticles can also be hollow particles possessing a shell which is built up in layers. In this connection, the shell can be composed of at least two layers of polyelectrolytes having different charges or be composed of three or more layers of polyelectrolytes having charges which in each case alternate. The layers of the shell can furthermore be crosslinked covalently or by means of bridging bonds. Preference is furthermore given to the at least one component being introduced into the hollow particles.

Other suitable microparticles can be found in WO 99/47252 and WO 00/03797, the entire disclosure contents of which publications are hereby incorporated by reference.

The microparticles can, for example, serve as templates for producing hollow particles. The templates can be present as whole bodies or even as hollow bodies. They can be solid, liquid or gaseous. In addition to this, the microparticles can be
templates which are already coated and which are subjected to further coating,
templates which are already provided with a shell whose core, i.e. the microparticle, is disintegrated and removed from the shell, or
microparticles into which appropriate components are introduced.

The modification of the microparticles therefore preferably comprises
coating the microparticles with the at least one component, and/or
using the at least one component to disintegrate microparticles which are coated with a shell, resulting in the formation of hollow structures, and/or
introducing and/or concentrating the at least one component into/in the microparticle(s).

The components which are used for the modification can be chemical substances, e.g. molecules (organic/inorganic/biological small molecules or macromolecules) or nanoparticles, i.e. small particles which are substantially smaller than the microparticles to be modified such that they can, for example, be introduced into the microparticles or are suitable for constructing a shell around the microparticles. When the microparticles are disintegrated, the coating should preferably not be modified or only modified slightly.

The components which are used can be brought to the microparticles by means of induced, in particular directional, transport. In this connection, an induced transport is understood as meaning a flow of the components through the gelatinous carrier medium, which flow is driven by the choice of suitable external conditions, resulting in it being possible for the components to be transported to the microparticles and, where appropriate, to be transported away from the microparticles once again. Induced or active transport is understood as meaning, for example, the transport which is driven by
electrical, magnetic, dielectrophoretic, optical or mechanical forces and/or
osmotic, thermal, hydrostatic or hydrodynamic forces, and/or
forces which arise in connection with phase transitions, such as evaporation, drying, solidification, melting and sol-gel and gel-sol transitions.

However, these forces can also act on the embedded microparticles. For this reason, the gelatinous carrier medium and the forces employed for the directional transport of the components should be matched to each other such that, while the forces acting on the microparticles only lead to slight or negligible movement of the microparticles, the components are, on the other hand, transported to the microparticles sufficiently rapidly. Thus, after the microparticles have been fixed or immobilized in the gelatinous carrier medium (gel/gelatinous system), the components employed can be transported, in sufficient quantity and at an adequate rate, to the microparticles, and away from them, i.e. the components are to a large extent conducted through the gelatinous medium in a directional manner, by means of different forces and processes such as electrophoresis, dielectrophoresis and diffusion, inter alia. Either only one of said forces (e.g. electrical forces), or any arbitrary combination of these forces, can be used for inducing the directional transport. Passive transport, e.g. by means of diffusion alone, is also possible as an alternative or in addition. An advantage of the induced transport is, in particular, a conduct of the process which is accelerated and which can be controlled more effectively and which makes it possible to achieve a higher yield.

It is furthermore advantageous if the forces employed for the transport are set such that they are smaller than the interaction between the components and the microparticles. This makes it possible to avoid the components being transported through the gelatinous carrier medium without any significant interaction with the microparticles, i.e. it makes it possible to ensure that the components are able to interact with the microparticles. In this way, the latter form a type of sink for the components. This is particularly advantageous in the case of components for coating the microparticles.

Examples of suitable gelatinous supporting media are hydrogels, i.e. aqueous gelatinous systems. The latter make it possible for the microparticles to be immobilized in a particularly advantageous manner, i.e. the microparticles are fixed in an almost stationary manner. On the other hand, hydrogels still allow adequate diffusion for, for example, polymeric coating components; i.e. hydrogels are to a large extent permeable to many components for coating and modifying the microparticles. The carrier medium can be composed of natural or synthetic hydrogel-forming agents or be composed of inorganic compounds or mixtures of inorganic and organic compounds. In addition, the carrier medium can be at least partially crosslinked covalently.

Preference is furthermore given to the carrier medium being noncontinuously particulate, in connection with which it can be composed of spherical, cylindrical, ellipsoidal or other regular forms. In this context, the carrier medium can be mounted, as an outer or inner layer, on monodisperse or heterodisperse supporting particles of simple or composite nature. The particulate carrier medium preferably possesses a characteristic size of less than a centimeter. Preference is furthermore given to the particulate carrier medium being integrated in the form of a column.

In another embodiment, the carrier medium is continuous. In this connection, it can possess characteristic measurements of less than a centimeter in one or two dimensions.

In principle, the continuous and noncontinuous carrier medium can be arranged in the form of columns, planar layers, parallel planar layers, strips and strips in parallel or meandering form. It is advantageous if the arrangement and the form of the continuous and noncontinuous gel matrices are optimized for higher rates of coating, modification, or separation from the gel matrix, of the nanoparticles and microparticles due to the abovementioned driving forces. In this connection, the continuous and noncontinuous gel matrices can be embedded in devices which generate the driving forces which are suitable for the coating, modification and separation processes.

In another embodiment, the carrier medium is applied to a carrier. In this connection, the carrier should be permeable to the at least one component.

A subsequent chemical or physicochemical modification of the coated microparticles, such as the disintegration of the microparticles employed as template, the removal of the released components from the gelatinous carrier medium and the preparation of a capsule shell which thereby results, is also possible while avoiding any aggregation or coagulation.

The coating of microparticles in the gel can be carried out in a wide variety of ways. Conditions under which electrical or diffusion forces fulfill the transport function are particularly advantageous. In particular, gel electrophoresis is suitable for transporting the components to the microparticles in a simple, directional and readily controllable manner. In gel electrophoresis, a static electrical field is usually applied over a gel or a gelatinous carrier medium, with the field resulting in the directional transport of charged components, e.g. polyelectrolytes, through the gel. In this connection, the components also come into contact with the microparticles which are embedded in the gelatinous carrier medium and modify these microparticles, for example by becoming attached to their surface. The transport can also be effected by means of directional diffusion, for example driven by a concentration gradient. It is likewise possible to have a combination of different transport processes. These induced transport processes markedly increase the efficiency and speed of the coating and modification processes.

The coating of microparticles is particularly preferred. Specific arrangements for this purpose, e.g. which coating components are suitable, how these are applied and how the templates which have been employed are released from the formed shell after the coating has taken place, can be found, for example, in the abovementioned WO 99/47252, the entire disclosure content of which is hereby incorporated by reference. Particular preference is given to the microparticles being coated with a shell composed of at least two, particularly preferably of at least three or more, layers of polyelectrolytes of differing charge. In this connection, polyelectrolytes of differing charge are applied alternately. The shells, shell structures or hollow particles which are formed in this way can even possess up to 20 or more, for example 40, layers of polyelectrolytes. The components which are used for the coating can be water-soluble organic polymers such as polyelectrolytes or polyampholytes, biopolymers, enzymes or charged oligomeric compounds, and also derivatives of these compounds The component(s) which is/are used for coating the microparticles can also be (a) compound(s) from the class of compounds approved for pharmaceutical uses and/or (a) compound(s) from the class of compounds approved for nutrients or the environment and/or a nutrient or (a) nutrient supplement(s).

In particular, the component employed for coating the microparticles comprises inorganic polyelectrolytes such as inorganic nanoparticles which are stable in aqueous solution; such as inorganic semiconductor particles; fluorescent nanoparticles; quantum dot particles such as CdSe; silica particles and inorganic nanoparticles which are stabilized by charge adsorption, such as magnetite and mineral particles.

The component which is employed for coating the microparticles can also comprise low molecular weight, at least doubly charged cations or anions. The component can likewise contain low molecular weight singly charged cations or anions which, as a result of their molecular structure, possess high affinity for the microparticles or other coating components. In principle, the component which is employed for coating the microparticles can be present in solid, liquid, liquid-crystalline or gaseous form or one of their intermediate forms.

After the microparticles have been modified, they are removed from the gelatinous carrier medium. This can be achieved, for example, by lowering the viscosity of the carrier medium and subsequently separating off the modified microparticles from the carrier medium, which is now of low viscosity. In this connection, the viscosity of the carrier medium is preferably lowered by the carrier medium undergoing a gel-sol transition, for example as a result of the carrier medium being heated or as the result of a dispersing agent being added. On the other hand, it is also possible to remove the modified microparticles by, for example, chemically disintegrating the carrier medium, which is still gelatinous, and then separating off the modified microparticles. For the purpose of removing or separating off the modified microparticles from the gelatinous carrier medium, recourse can also be had to
physical methods such as sedimentation, centrifugation, filtration or vibration; and/or
physicochemical methods such as phase separation, phase transition, coagulation, aggregation, demixing or solidification front, and/or
chemical methods such as crosslinking.

Where appropriate, the gelatinous carrier medium can initially also be comminuted mechanically and then disintegrated or have its viscosity lowered. Preference is given to thermal processes for disintegrating/liquefying the gelatinous carrier medium and to subsequent separation, and, where appropriate, washing, processes for separating off the microparticles.

In principle, the viscosity of the carrier medium can be lowered, after the microparticles have been modified, by means of thermal, chemical, electrical, physicochemical, optical, mechanical, rheomechanical or biological processes and parameters.

It is possible to conceive of a variety of geometrical configurations for the in-gel coating arrangements (LBL in-gel, in-gel nanoparticle coating); in this connection, one has in mind, in particular, good possibilities for scaling up. The rule is to maximize the overall surface of the gelatinous carrier medium and to optimize the third dimension, which is normal to the surface, because this dimension locally determines the coating and modification intensity (rate) while the overall surface determines the quantity of product.

It is advantageous if the gelatinous carrier medium has a comparatively large surface such that the components can rapidly be taken up by the carrier medium and arrive at the microparticles. For example, the gelatinous carrier medium can be present as a thin plate, with the components being supplied to the carrier medium by way of in each case at least one of the two large lateral faces. It is furthermore advantageous to use the gelatinous carrier medium in the form of particles, e.g. spherical particles, with the particles being larger than the microparticles to the extent that they allow the micro particles to be embedded. Where appropriate, the gelatinous carrier medium can be arranged on carriers, e.g. sieves, small spheres or the like.

The invention furthermore relates to a device for modifying microparticles having a first chamber and a second chamber, in connection with which the chambers can be filled with in each case one liquid and are delimited from each other by arranging a gelatinous carrier medium between them, with the distance between the two chambers being defined by the thickness of the carrier medium, with the gelatinous carrier medium forming a contact area with each chamber, and with the extent of at least one contact area being greater, in at least one direction, than the distance between the two chambers.

The contact areas which are formed between the gelatinous carrier medium and the chambers should, in at least one direction, preferably in two directions, have an extent which is greater than the distance between the two chambers such that components from the chambers can enter the carrier medium relatively rapidly. The extent of the contact area in at least one direction should preferably be at least 2 times, particularly preferably at least 5 times, greater than the thickness of the gelatinous carrier medium and, as a consequence, the distance between the two chambers should be correspondingly small. The aim is for the absolute ratio of the contact area between the gelatinous carrier medium and the chambers to the volume of the gelatinous carrier medium to be as large as possible. The contact time which is required for modifying the microparticles which are embedded in the gelatinous carrier medium can be reduced by a correspondingly large contact area/volume ratio, thereby achieving a higher throughput.

It is advantageous if the gelatinous carrier medium seals off the two chambers from each other such that components can only be transported by way of the gelatinous carrier medium.

Preference is furthermore given to the chambers being delimited, on their sides which are in each case facing away from the intercalated carrier medium, by in each case at least one membrane which is opposite in each case a first or second functional chamber. This makes it possible, for example, to introduce suitable components selectively into the chambers, with the components being prevented by the membrane from passing through into the functional chambers. The latter serve, for example, as chambers for supplying transport liquids or the like, with membranes of correspondingly large area being advantageous, for example for ensuring the supply of transport liquids. The membranes are preferably then of about the same extent as the contact areas between the gelatinous carrier medium and the two chambers.

In each case at least one electrode, between which it is possible to apply a voltage, is advantageously arranged in each functional chamber. These electrodes are used, for example, for transporting the components by means of the electrophoretically driven process. The electrodes are preferably designed as plates in connection with which they can be arranged essentially parallel to the gelatinous carrier medium which is inserted.

A device of this nature makes it possible to coat microparticles which are embedded in the gelatinous carrier medium with polyelectrolytes in a manner which is comparatively efficient and which can be readily controlled. The gelatinous carrier medium can, for example, be a suitably solidified gel which can, for example, also be arranged on a carrier which is permeable for the components, e.g. polyelectrolytes, and which is to a large extent mechanically stable.

The invention furthermore relates to a carrier material comprising a carrier and a gelatinous carrier medium in which microparticles are embedded, with the carrier being permeable for components which are smaller than the microparticles. The gelatinous carrier medium is preferably a gel.

The invention furthermore relates to a column comprising a hollow body which is at least partially filled with a large number of particles, with it being possible to conduct a liquid through the hollow body and over the particles, and with the particles exhibiting a gelatinous carrier medium in which the microparticles are embedded. The principle of the structure of columns is known from analytical chromatography. However, in the column according to the invention, the particles which are arranged in the hollow body exhibit a gelatinous carrier medium in which microparticles are embedded. The gelatinous carrier medium is preferably a gel.

The particles can consist entirely of the gelatinous carrier medium or possess a core which is enveloped by the gelatinous carrier medium.

In that which follows, the invention is described with the aid of an exemplary embodiment and depicted in figures:

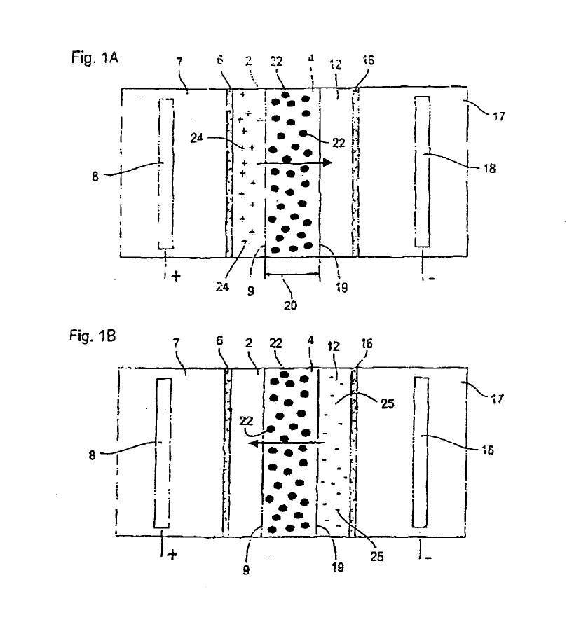

FIGS. 1A and 1B show a device for coating micro-particles;

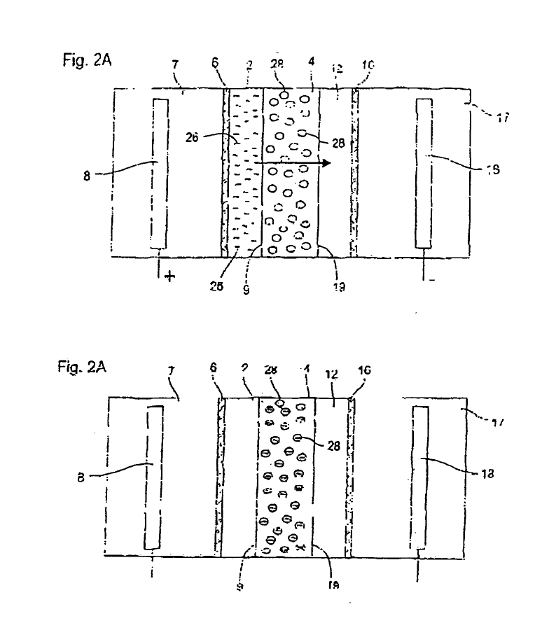

FIGS. 2A-2B show a device for loading micro-particles with an active compound;

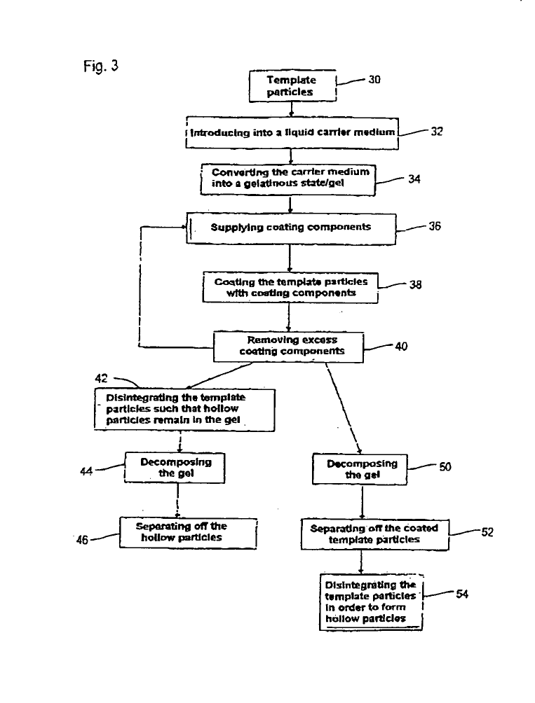

FIG. 3 shows individual steps when coating microparticles;

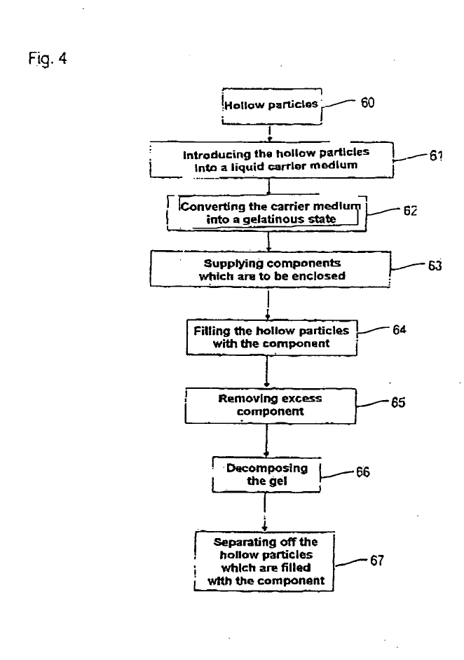

FIG. 4 shows individual steps when loading a hollow particle with an active compound;

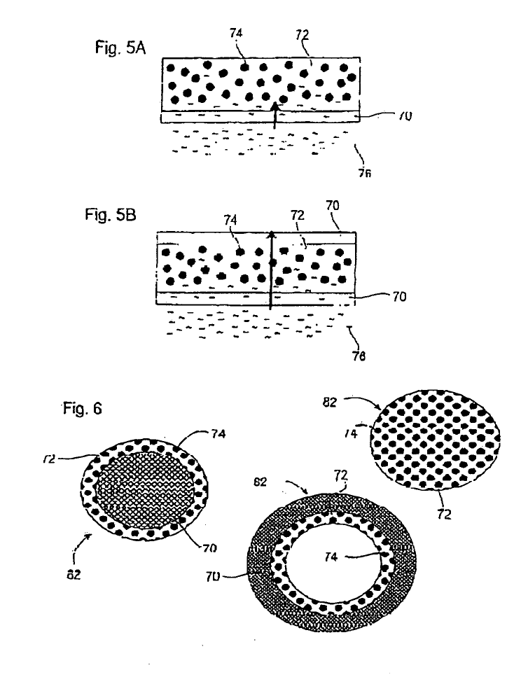

FIGS. 5A and 5B show planar carrier materials;

FIG. 6 shows spherical carrier materials; and

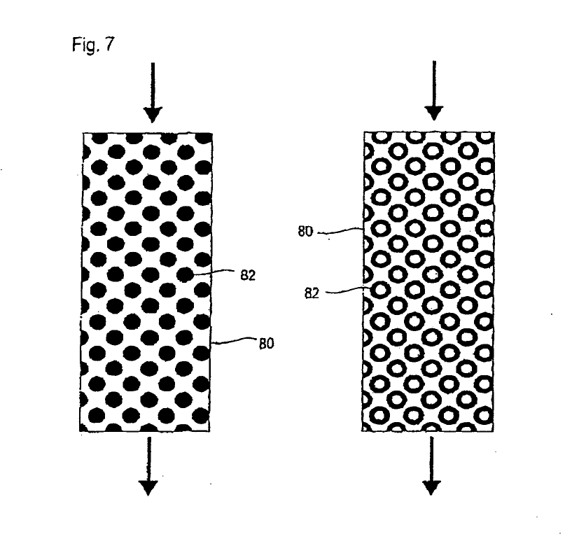

FIG. 7 shows columns which are filled with carrier materials.

FIG. 1A shows a device for, for example, coating microparticles. The device possesses a first chamber 2 and a second chamber 12 which are separated from each other by means of a gelatinous carrier medium 4, for example in the form of a solidified gel. The two chambers 2 and 12 are filled with a carrier liquid, with it being possible, however, for an exchange of carrier liquid to take place through the gelatinous carrier medium 4. On their sides which are in each case facing away from the gelatinous carrier medium 4, the chambers 2 and 12 are separated by membranes 6 and 16 from functional chambers 7 and 17 which are likewise filled with a carrier liquid or the same carrier liquid. An electrode 8 and 18, by way of which an electrical voltage is applied, is in each case arranged in these functional chambers such that an electrical field is constructed. In the region of the gelatinous carrier medium 4, the field lines run approximately perpendicularly to the gelatinous carrier medium 4.

The distance 20 of the two chambers 2 and 12 from each other is determined by the thickness of the gelatinous carrier medium. This distance is smaller than the extent of the contact areas 9 and 19 which are formed between the gelatinous carrier medium 4 and the chambers 2 and 12.

Microparticles 22 are embedded in the gelatinous carrier medium 4, which can, for example, be a low-melting-point agarose gel. Examples of suitable microparticles are RNA or DNA molecules or silica particles or soluble melamine formaldehyde particles of a size of from about 30 nm to 10 μm. Other suitable microparticles can be found in the abovementioned WO 99/47252 and WO 00/03797.

In order to coat the embedded microparticles 22, the two chambers and the functional chambers are filled with a suitable medium, for example with an acetate buffer, and coating components 24, e.g. polycations, are introduced into chamber 2; the polarity and the strength of the electrical field are then adjusted such that the polycations are moved in the direction of the gelatinous carrier medium 4 and migrate through the gelatinous carrier medium. The microparticles 22 preferably exhibit a negative surface charge such that the polycations remain at the surface of the micro-particles, as a result of electrostatic interaction, and accumulate there until the charge on the surface has been reversed.

Excess polycations are conveyed into the second chamber 12 and can be removed from this chamber. After an optional washing step, other coating components 25, for example polyanions, are introduced into the second chamber 12 and moved by the electrical field in the direction of the first chamber 2 in connection with which they coat the surface of the microparticles and reverse the charge on this surface once again.

These steps can be repeated as frequently as required. It is also possible to always introduce the coating components into the first chamber 2 but correspondingly to adapt the polarity of the applied electrical field to the polarity of the coating components.

FIGS. 2A and 2B show devices which in principle have the same structure as those shown in FIGS. 1A and 1B; however, in this case, an active compound 26 is introduced into the microparticles 28. Provided the active compound is present as an ion or is provided with a charge, the transport can be driven by an electrical field. Alternatively, it is also possible to conceive of transport due to a concentration gradient. FIG. 2B shows the microparticles 28 loaded with the active compound 26.

FIG. 3 provides an overview of the course of a coating process. Template particles are first of all provided in step 30 and then introduced into, for example suspended uniformly in, a liquid carrier medium in accordance with step 32. This is followed, in step 34, by the conversion of the carrier medium into a gelatinous state or into a gel which permits adequate immobilization of the microparticles while at the same time permitting adequate mobility of the coating components which are to be subsequently added (step 36). Hydrogels, for example, fulfill these requirements. The template particles are then coated, in step 38, with the coating components, which are moved through the gelatinous carrier medium by means, for example, of electrical forces. After that, excess coating components are removed in accordance with step 40 and a rinsing step is carried out, where appropriate. Steps 36 to 40 can be repeated as frequently as required until the desired coating thickness or number of layers has been achieved.

In conclusion, the templates are disintegrated and the hollow particles which are thus formed, and which constitute the coating shell which has been previously applied, are removed from the gelatinous carrier medium. This can be effected, for example, by first of all disintegrating the template particles in accordance with step 42 such that the hollow structures which remain continue to be embedded in the gelatinous carrier medium. This is then followed by the gel or the gelatinous carrier medium being decomposed in step 44 and the hollow structures being separated off from the decomposed gel in step 46. As an alternative, the gel can be decomposed first of all (step 50) after which the coated template particles can be separated off (step 52) and the template particles finally disintegrated (step 54) such that hollow structures remain. In both the abovementioned variants, the gel or the gelatinous carrier medium can be decomposed chemically or by, for example, thermally liquefying the gel.

FIG. 4 shows, by way of example, individual steps performed when filling hollow particles with a component. Hollow particles are first of all provided (step 60) and suspended in a liquid carrier medium (step 61). The carrier medium is then converted into a gelatinous state or a gel (step 62) and the components are supplied (step 63), with these components gaining entry to the hollow particles and becoming concentrated in these particles (step 64). The filling of the particles can, for example, be controlled such that pores are opened in the walls of the hollow particles and then closed after the particles have been filled such that the enclosed components can no longer leave the hollow particles. In the case of hollow particles consisting of polyelectrolytes, the pore size can be adjusted, for example, by way of the ionic strength of the medium surrounding the particles.

Excess components are then removed (step 65), the gel is decomposed (step 66) and the hollow particles which are filled with the components are separated off from the decomposed gel (step 67).

FIGS. 5A and 5B show carrier materials together with a support 70 on which a gelatinous carrier medium 72, together with microparticles 74 which are embedded therein, is arranged. The support 70 is permeable to the components 76 which are indicated and which are to gain entry into the microparticles. The carrier can, for example, be a sieve. The gelatinous carrier medium 72 can also be bounded by the carrier 70 on both sides. The carrier 70 is used, in particular, for mechanical stabilization such that prepared gelatinous carrier media, together with microparticles which are embedded therein, are easier to manipulate. The carrier 70 can also extend in the gelatinous carrier medium 72.

FIG. 6 shows spherical carrier materials 82 in which the gelatinous carrier medium 72 either envelops a spherical carrier 78 or coats the inner side of a hollow spherical carrier 79. On the other hand, it is possible for the gelatinous carrier medium/gel 72 to be present, without carrier, in the form of particles 82, e.g. spherical particles, in particular whole spheres, in which microparticles are embedded.

FIG. 7 depicts columns which exhibit a hollow body 80 which is filled with a large number of particles 82. These particles can, for example, be the spherical carrier materials 82 or particles 82 which are shown in FIG. 6. However, the particles 82 can also consist entirely of the gelatinous carrier medium, in particular a gel, in which microparticles are embedded. A liquid, which is indicated by the arrows and in which components for coating or filling the embedded microparticles are dissolved, can be conducted through the columns. These columns are particularly simple to manipulate.

Example of Coating in a Gel:

Carefully purified silica particles are suspended, at 70° C., in 1% low-melting-point agarose gel (peqGold Low Melt Agarose PEQLAB; 0.05M acetate buffer, pH 6.5) and the whole is poured into a block measuring 2 cm×2 cm×1 cm. After having cooled down, the block is inserted into the reaction chamber of a specially produced gel electrophoresis cell, e.g. as shown in FIGS. 1A and 1B. The cell is subdivided into a cathode chamber 17, a reaction chamber (comprising chambers 2 and 12 as well as the gelatinous carrier medium 4) and an anode chamber 2 which are sealed off from each other by membranes 6 and 16. The electrodes 8 and 18 are platinum-coated titanium lattices which are supplied, in the appropriate size for the cell, by the company Metakem. The membranes (BioTrap BT1 moist from Schleicher & Schüll) are permeable to small ions but impermeable to the polyelectrolytes which are used. The gel block 4 in turn divides the reaction chamber into three regions. The region on the anode side (chamber 2) is filled with a 2 mg/ml solution of polycation in 0.05M acetate buffer. A voltage of 70 V is then applied using a power supply unit (CONSORT E 831 from PEQLAB) After 30 min, the entire quantity of polyelectrolyte has diffused out of the solution into the gel 4. In screening experiments, the movement of the polymer in the gel was monitored by using dye-labeled polymers. After a further 60 min, the remainder of the polycation, which has not become adsorbed to silica particles, has once again diffused out of the gel on the cathode side of the reaction chamber (chamber 12).

Both sides of the reaction chamber are rinsed with fresh acetate solution and the voltage is applied once again for 20 min in order to remove any last residues of the polycation from the gel.

In the next step, 2 mg/ml polyanion in 0.05M acetate buffer is added to the former anode chamber and the voltage of 70 V is applied again with reversed polarity. The polyanion now diffuses, in analogy with the polycation in the previous step, through the gel layer and is likewise removed. This cycle is repeated in accordance with the number of layers desired.

The coated particles can be separated off from the gel by melting the gel at 70° C. and centrifuging. They are subsequently washed 3 times with water at 70° C.

Example of Disintegrating the Coated Template Particles for the Purpose of Forming Hollow Structures:

Prior to separation from the gel, the cores (template particles) can be removed from the capsules (hollow structures) using 1M HF, thereby reducing the likelihood of aggregation. For this, the gel is comminuted into pieces of approximately 1 mm in size, with these pieces being treated with 1M HF in a filtration cell for 2 h and while stirring. After that, the solution is filtered off and the gel pieces are treated with fresh HF solution for a further 2 h. The hollow capsules are then separated off, in analogy with the particles, by melting the gel.

1. A method for modifying microparticles comprising:
providing a gelatinous carrier medium in which microparticles are embedded;
introducing at least one component into the gelatinous carrier medium and bringing the at least one component into contact with the microparticles by induced, directional transport, with the at least one component exhibiting a mobility in the gelatinous carrier medium which is higher than that of the microparticles;
modifying the microparticles with the at least one component to produce modified microparticles; and
removing the modified microparticles from the gelatinous carrier medium.

2. The method as claimed in claim 1, characterized in that the gelatinous carrier medium is a solid gel.

3. The method as claimed in claim 1, characterized in providing the gelatinous carrier medium comprises:
providing the carrier medium in a low-viscosity form;
introducing the microparticles into the carrier medium; and
increasing a viscosity of the carrier medium such that mobility of the microparticles in the carrier medium is restricted.

4. The method as claimed in claim 3, characterized in that the viscosity of the carrier medium is increased by converting the carrier medium into a gelatinous state or into a solid gel.

5. The method as claimed in claim 1, characterized in that the viscosity of the carrier medium is increased by the carrier medium undergoing a reversible sol-gel transition.

6. The method as claimed in claim 5, characterized in that the carrier medium is a gel which is liquefied by heating for the purpose of introducing the microparticles and is cooled down once again, for solidification, after the microparticles have been introduced.

7. The method as claimed in claim 5, characterized in that the carrier medium is a gel which is liquefied by adding a dispersing agent for the purpose of introducing the microparticles and the dispersing agent is at least partially removed once again, for solidification, after the microparticles have been introduced.

8. The method as claimed in claim 1, characterized in that modifying the microparticles comprises coating the microparticles with the at least one component.

9. The method as claimed in claim 1, characterized in that removing the modified microparticles from the gelatinous carrier medium is effected by lowering a viscosity of the carrier medium and separating off the modified microparticles from the carrier medium.

10. The method as claimed in claim 9, characterized in that the viscosity of the carrier medium is lowered by the carrier medium undergoing a gel-sol transition.

11. The method as claimed in claim 9, characterized in that the viscosity is lowered by heating the carrier medium.

12. The method as claimed in claim 9, characterized in that the viscosity is lowered by adding a dispersing agent.

13. The method as claimed in claim 1, characterized in that removing the modified microparticles from the gelatinous carrier medium is effected by decomposing the carrier medium and separating off the modified microparticles from the carrier medium that is decomposed.

14. The method as claimed in one of the preceding claims claim 1, characterized in that the microparticles are smaller than 30 micrometers.

15. The method as claimed in claim 1, characterized in that the microparticles are of biological origin or bio-technological origin.

16. The method as claimed in claim 1, characterized in that the microparticles are colloidal particles.

17. The method as claimed in claim 1, characterized in that the microparticles contain an active compound.

18. The method as claimed in claim 1, characterized in that the microparticles employed are disintegratable or soluble particles.

19. The method as claimed in claim 1, characterized in that the microparticles possess catalytic properties.

20. The method as claimed in claim 1, characterized in that the at least one component comprises water-soluble organic polymers.

21. The method as claimed in claim 1, characterized in that the at least one component is used for coating the microparticles and comprises a compound selected from pharmaceutical and cosmetic active compounds.

22. The method as claimed in claim 1, characterized in that the at least one component is used for coating the microparticles and comprises at least one inorganic substance.

23. The method as claimed in claim 22, characterized in that the at least one component used for coating the microparticles comprises inorganic polyelectrolytes.

24. The method as claimed in claim 22, characterized in that the at least one component used for coating the microparticles possesses catalytic properties.

25. The method as claimed in claim 1, characterized in that the at least one component is used for coating the microparticles and comprises water-soluble organic polyelectrolytes.

26. The method as claimed in claim 1, characterized in that the at least one component is used for coating the microparticles and is of biogenic or bio-technological origin.

27. The method as claimed in claim 1, characterized in that the at least one component is used for coating the microparticles and is labeled.

28. The method as claimed in claim 1, characterized in that modifying the microparticles includes consecutively coating the microparticles with at least two components for the purpose of forming a shell which comprises at least two layers.

29. The method as claimed in claim 28, characterized in that modifying the microparticles includes coating the microparticles with at least one further component for the purpose of forming a shell comprising at least three layers.

30. The method as claimed in claim 1, characterized in that the microparticles are hollow particles having a shell which is constructed in layers.

31. The method as claimed in claim 30, characterized in that the at least one component is introduced into the hollow particles.

32. The method as claimed in claim 1, characterized in that the carrier medium is composed of organic polymers.

33. The method as claimed in claim 1, characterized in that after the microparticles have been modified, the carrier medium is first of all comminuted and then decomposed.

34. A device for modifying microparticles having a first and a second chamber which are each capable of being filled with liquid,
wherein the first and second chambers are delimited from each other by a gelatinous carrier medium between them,
wherein a distance between the first and second chambers is defined by a thickness of the gelatinous carrier medium,
wherein the gelatinous carrier medium forms a contact area with each chamber, and
wherein an extent of at least one of the contact areas being is greater, in at least one direction, than the distance between the first and second chambers.

35. The device as claimed in claim 34, characterized in that the extent of each contact area is greater, in all directions, than the distance between the first and second chambers.

36. The device as claimed in claim 34, characterized in that on sides of the first and second chambers which are in each case facing away from the gelatinous carrier medium, the first and second chambers are in each case delimited by at least one membrane which is in each case opposite a first and, respectively, second functional chamber.

37. The device as claimed in claim 36, characterized in that each membrane has approximately a same extent as the contact areas between the gelatinous carrier material and the first and second chambers.

38. The device as claimed in claim 36, characterized in that each functional chamber is capable of being filled with liquid and contains at least one electrode.

39. The device as claimed in claim 38, characterized in that the electrodes are designed as plates arranged essentially parallel to the gelatinous carrier medium.

40. The method as claimed in claim 1, characterized in that modifying the microparticles comprises using the at least one component to disintegrate microparticles which are coated with a shell, resulting in the formation of hollow structures.

41. The method as claimed in claim 1, characterized in that modifying the microparticles comprises introducing the at least one component into the microparticles.
